(19) United States
(12) Patent Application Publication
(10) Pub. No.: US 2013/0312547 A1
(43) Pub. Date: Nov. 28, 2013

(54) ONLINE SAMPLING APPARATUS AND METHOD FOR ONLINE SAMPLING

(71) Applicant: Thomas Kniep Jørgensen, Kolding (DK)

(72) Inventor: Thomas Kniep Jørgensen, Kolding (DK)

(73) Assignee: SOURCE TECHNOLOGY APS, Kolding (DK)

(21) Appl. No.: 13/994,497

(22) PCT Filed: Dec. 20, 2011
(86) PCT No.: PCT/DK2011/050505

§ 371 Date: Jun. 14, 2013

(30) Foreign Application Priority Data
Dec. 21, 2010 (DK) PA 2010 70564

(51) Int. Cl. G01N 1/20

(52) U.S. Cl. CPC G01N 1/20
USPC 73/864.51

(57) ABSTRACT

An apparatus and a method for online sampling from a product flow, where the sampling is performed continuously by introducing a cup, provided with an opening, directly into a product flow where the flowing product is collected in the cup for determining one or more physical conditions, for example, weight in relation to volume, moisture, size and/or color. The apparatus has at least a slidable cup and a device for sliding the cup. The apparatus also has a filter element and a device by which the filter element is brought into position in relation to an opening in the cup, an aerator for aeration of the sample taken in the cup, and at least a set of sensors for determining the presence of contents and/or physical conditions of the contents in the cup.

### BACKGROUND OF THE INVENTION

1. Field of the Invention

The present invention concerns an apparatus for online sampling from a product flow, where the sampling is performed continuously by introducing a cup, provided with an opening, directly into a product flow where the flowing product is collected in said cup for determining one or more physical conditions, for example, weight in relation to volume, moisture, size and/or color. The apparatus comprises at least a slidable cup and means for sliding said cup. The invention further concerns a method for using such an apparatus.

2. Description of Related Art

It is common knowledge to perform sampling, e.g., measuring density of products, such as e.g., expanded and heat treated products, but also of other products where the products appear with a certain porosity during the manufacturing process, and where the product is desired to be continuously weighed in order thereby to regulate the processes controlling the expansion and thereby the porosity of the weighed product. Likewise, it may be desired to determine, for example, size and color of a product in connection with manufacturing or conveying in a piping system for the product.

Density measurement is presently performed in various ways. Systems based on a specifically defined volume which is filled with products and subsequently weighed are the most widely used technique. This technique is frequently used at a purely manual level, where a process operator manually fills a tare weighted container with a known volume with products. The same applies to a wide extent to the way in which the other conditions in product samples are determined.

During the making of these different products, which often occurs under high temperature by means of a compacting or extruding machine, the process parameters can be changed such that the texture of the given product is changed, entailing a change of the density of the product as well. A given product will frequently have a specific intended volume, color or hardness. This may, e.g., be in connection with packing a product where a given density or strength of the product is wanted in order thereby to handle the product in an optimum way. By changing the addition of either energy in the form of heat, moisture or other similar process parameters for making a given product, the characteristic of the product can be changed and thereby also the physical properties of the product.

The problem of manual sampling is that the repeatability is not great enough and that the weighing result therefore only can be used as an indication and not as a completely true value. This is due to the fact that a process operator is not able to fill a given sampling container in a uniform way. On this background, automatic systems have been manufactured which may perform continuous uniform sampling and weighing of the products. These systems are satisfactory for specific products and sizes of products; however, in industries as, e.g., for the making of snacks, cereals and feed for animals, the products are often relatively large and often they are also sticky as a result of the heating process by which the product is formed.

The best known prior art for sampling is based on a sampling cup mounted on an arm which may be displaced horizontally and which is mounted on a weighing cell. The sampling cup is moved into a given product flow whereby the cup is (over)filled with product. When the cup is retracted to the weighing area, the sampling cup is scraped clean at the top in order to provide a defined volume of the product to be weighed. When the sample has been weighed, the cup is emptied by its being turned or by opening of the cup bottom whereby the product is emptied from the sampling cup. Such a sampler is known from, for example, WO 2009/092378 and corresponding U.S. Pat. No. 8,141,418.

However, there are a number of conditions in connection with direct sampling from a product flow for which improvements are wanted as not all condition measurements can be performed by means of the prior art solutions and consequently, in several cases, it is not possible to perform continuous and rapid regulation of one or more process parameters.

Thus, there are considerable improvements to be made, for example, when it comes to determining, amongst other conditions, color, size, buoyancy and hardness of the products being manufactured.

### SUMMARY OF THE INVENTION

Thus, it is the purpose of the present invention to provide an online sampling apparatus for determining one of more of the said conditions. Furthermore, it is also the purpose to provide a method by which such an online sampling apparatus can be operated.

As mentioned in the introduction, the invention concerns an apparatus and a method for online sampling from a product flow, where the sampling is performed continuously by introducing a cup, provided with an opening, directly into a product flow. The apparatus further comprises a filter element and means by which the filter element is brought into position in relation to an opening in said cup, aeration means for aeration of the sample taken in the cup, and further comprises at least a set of sensor means for determining the presence of contents and/or physical conditions of the contents in the cup. The reason for the filter element or cup comprising means for adjusting the filter element is that density of the filter element can thereby be adjusted. For example, the filter element can be activated and/or adjusted so that particles of a certain size will remain in the cup after completed aeration. When the filter element is activated, via the aeration, the product can be whirled around in the cup whereby “small”-size particles pass through the filter element, and “large”-size particles are retained in the cup.

At the same time, the filter element method can also be used for ensuring that the products in the cup are cooled and/or distributed, for example, in an even layer at the bottom of the cup. This may have great influence on the possibility of determining the wanted physical properties of the product. When the filter element is activated, it is ensured, that the product is not whirled out of the cup during cooling of the product by compressed air. This is especially useful in connection with warm and moist products that are to be analyzed by sensors sensitive to vapor such as a camera with a lens on which vapor from the product can condense.

The filter element can advantageously be constructed in such a way that it works by a size-adjustable slit for example, between the cup and a lid. It is thus the slit that constitutes the filter element, and the size of the slit that determines how large particles are to be retained in the cup. The size of the slit can be adjusted to the specific requirement and be regulated by adjusting the mutual distance between lid and cup. However, more specific filter elements can be used which have a given size of meshes or openings in a sieve of metal or other suitable material, for example, plastics or paper. Such an embodiment can advantageously be provided with different mesh sizes by which the filter element can be adjusted to meet different requirements.

As mentioned above, an apparatus for online sampling according to the invention can be designed in such a way that the means for positioning a filter element in relation to the cup are adjustable and arranged in such a way that the distance between the two items can be adjusted.

In a preferred embodiment of an apparatus for online sampling according to the invention the aeration means can comprise at least one opening through which opening compressed air is supplied or a suction is provided where said at least one opening is in direct or indirect connection with the cup or filter element of the apparatus. The so-called aeration may serve various purposes. As already mentioned, the purpose can be to separate small particles from large particles, and a purpose can be to cool and/or distribute the remaining products in the cup. This can advantageously be achieved by aeration with compressed air which via one or more nozzles is supplied to the cup. One or more of such nozzles can be arranged in the actual filter element, but can also be arranged in the cup. It is further a possibility that the nozzle or a flow of air is supplied via the openings in the filter element. As is the case for supply of air or the like, suction can be provided. Suction will also be able to act on the products to such a degree that they are whirled around in the cup, and it will be possible to remove small particles from the cup. Obviously, a combination of for example, air supply and suction can also be used.

Thus, for example, a product sample taken can be weighed upon which the sample is aerated or in some other way whirled around in the cup by which small particles are removed or sucked away. These removed particles can be collected and weighed or subjected to other analyses. Also, the remaining large-size particles can subsequently, or at the same time, be subjected to more analyses. An apparatus for online sampling according to the invention can advantageously comprise means for detection of fat, protein and/or water content, for example, an IR (infrared) or MR (near infrared) sensor.

In another preferred embodiment of an apparatus for online sampling according to the invention, the apparatus can comprise means for exertion of a mechanical action on the product sample taken from the product flow. Such means can, for example, be means for grinding a product sample in the cup, but they can also be means for action on the product which can, for example, be in the form of pellets by which the hardness can be determined on the basis of the contents of large and small particles in the sample. As for grinding of the product by, for example, a rotating knife, this can be used for ensuring a more precise measurement as certain properties in a product cannot instantly be detected by the means of sensors which measure on the surface or the outer layer of the product. In certain cases this will provide a more precise measurement if the measurement is made on a more or less powdered product which is possible after the product sample taken, or parts of it, has been acted upon mechanically for grinding.

A further embodiment of an apparatus for online sampling according to the invention can advantageously comprise a liquid-filled chamber and means for positioning the product sample taken in the liquid-filled chamber, and further comprise means for determining whether a part of the product floats in the liquid after an adjustable interval of time. The said means for positioning the product sample taken in the water can in a simple manner be constituted by an openable bottom in the sampling cup or by mechanical means capable of turning the cup in such a way that the product sample taken is emptied from the sampling cup. As mentioned above, emptying is down into a liquid-filled chamber. When the product has been in the water for a given interval of time, detection is made to determine whether product floats on or near the surface of the water. This detection can advantageously be effected using one or more cameras, and depending on whether product is expected to be in the water surface or not, the result of the sample can be used to regulate the preceding process, or used as an acceptance criterion.

Detection can be made in various ways and in a possible embodiment, mechanical means can be brought into a position between the water surface and the bottom of the said chamber thereby delimiting the upper chamber upon which a camera from above can detect whether product is in the water. In principle, this method can also be used after the water has been discharged from this upper chamber but where products may have been retained at the bottom in the chamber. Another possible solution is using one or more cameras mounted below the water surface which camera or cameras thus “looks” up under products, if any, floating on the surface as these other products have sunk so deep that the have passed this or these cameras. Upon detection completion the sample, now containing water and products, can be discharged from the chamber by opening of a bottom valve. To have a uniform amount of water supplied into the chamber prior to supply of the product, the correct amount of water can be measured by means designed for this purpose, which water is supplied to the chamber immediately before or at the same time as when the product is supplied. By such an apparatus the required continuous inspection of floating or sinking properties, and sinking speed of the product can be performed, and adjustment, if any, of various process parameters can be made.

As mentioned above, the invention also concerns online sampling from a product flow by means of an apparatus according to the invention where the sampling is performed continuously by introducing a cup, provided with an opening, directly into a product flow where the flowing product is collected in the said cup for determining one or more physical conditions, for example, weight in relation to volume, moisture, size and/or color. What is new about a method according to the invention is that the method comprises at least three of the following four steps:
taking a sample
arranging the sample taken in a detection area
aeration of the sample by means of compressed air or suction and thereby filtration of the product
activation of a sensor for determining the presence and/or size of products in the cup.

By such a method it is possible to perform high-quality continuous control of the current product so that selected properties or physical conditions of the product can be determined.

A method according to the invention can advantageously comprise at least one of the following steps:
determining the weight of either the residue product or the filtrate product.
determining the size of residue products.
determining the number of residue products.
   By using one or more of these steps high-quality and sufficient control can be performed in an automatic, rapid and efficient way.

More advantages and embodiments of the invention will be described below in the detailed description in conjunction with the accompanying drawings.

### BRIEF DESCRIPTION OF THE DRAWINGS

FIGS. 1a-1e show an apparatus for online sampling where large-size particles are detected in a powder product.

FIG. 2a-2c show an apparatus for online sampling where black particles are detected in a white powder product.

FIG. 3a-3e show an apparatus for online sampling where the sizes of the individual product items are measured.

FIG. 4a-4e show an apparatus for online sampling where grinding of the product is effected prior to analysis by means of an NIR sensor.

FIGS. 5a & 5b show an apparatus for online sampling where test of the sinking or floating properties of the product is performed in a two-chamber system.

FIGS. 6a & 6b show an apparatus for online sampling where test of the sinking or floating properties of the product is performed in a single chamber.

FIGS. 7a & 7b show an apparatus for online sampling where test of the resistance of the product to a certain rough treatment is performed, including subsequent analysis of the result.

### DETAILED DESCRIPTION OF THE INVENTION

The present invention concerns an apparatus for online sampling of a product from a product flow, where the product sample is taken in a cup and subsequently subjected to one or more process steps for determining selected properties and conditions.

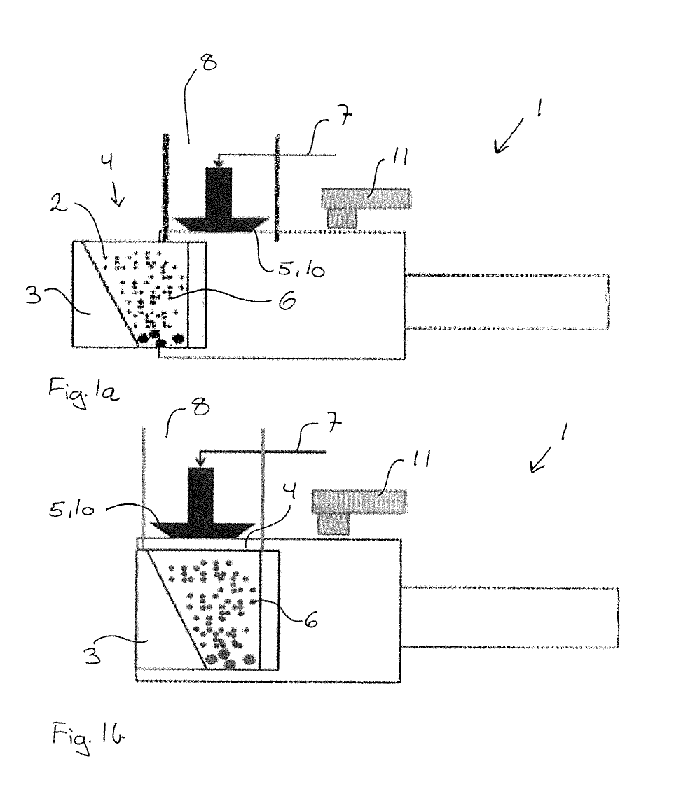

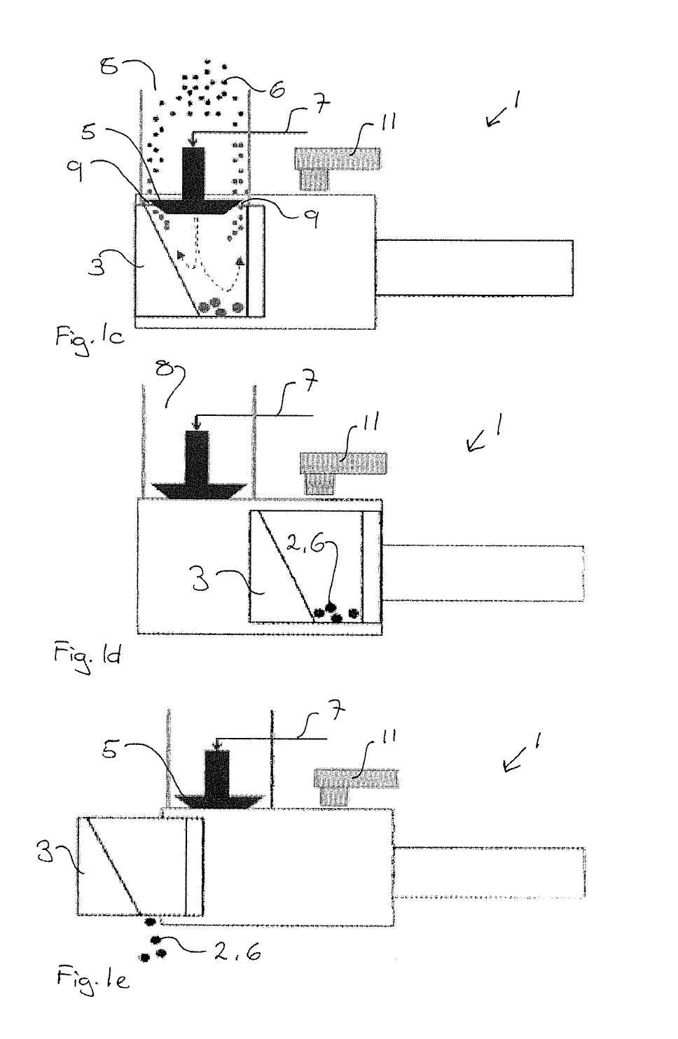

FIGS. 1a-1e show an example of a process, where, by using camera inspection, it is determined whether there are so-called large-size particles in a powder product. In connection with manufacturing of powder products, typically a particle reduction machine is applied, for example, a hammer mill. Such a particle reduction machine comprises a perforated sheet or plate, typically a metal sieve with openings allowing powder particles to pass through when they have been reduced to the wanted size. In such production plants there are, as in connection with operation of many other production plants, routines for service inspections and checks. This is necessary in order to ensure that the plant is optimum, and that it works fully as intended. However, it may occur for example, that, due to wear or overload in the form of unintended access by a small stone into the particle reduction machine, said sieve may become defective thereby allowing too large particles to pass through which means that some of the particles have not been reduced to the wanted particle size, and thereby the powder becomes coarser than intended.

Using an online sampling apparatus 1 according to the invention it is possible to perform continuous inspection of the particle size and thereby determine whether there are defects in for example, a sieve in a particle reduction machine. The product sample 2 is taken in the usual way from the product flow into a sampling cup 3 which is drawn out of the product flow. Hereafter, the opening 4 of the cup is covered with means 5 which allows only particles 6 having the acceptable size to be discharged from the cup 3. The particles 6 can, for example, be acted upon by compressed air 7 or by suction provided in a pipe connection 8 whereby they are whirled around and out of the cup 3 through the means 5. These means 5 can, for example, be a sieve or a slit 9 in a lid 10, or the like, which is placed over the opening 4 of the cup. When particles 6 or powder have been whirled around for a suitable period of time, supply of compressed air 7 is stopped, or any other means causing the particles 6 to be whirled around are stopped. Hereafter, by means of a camera 11 it is checked whether there are contents in the cup. If the cup is empty, no action is taken, but if there are particles 6 in the cup, the appropriate action is taken. The said camera 11 is electronically connected to electronic equipment and software by which it is possible to automatically determine whether there are particles 6 in the cup 3 or not. The process of sampling and determining whether there are large-size particles 6 or not can at least comprise the following steps:

FIG. 1a and FIG. 1b show how a sample is taken to a cup 3 from the product flow.

FIG. 1c shows how the sample 2 is aerated/whirled around while at the same time a spacer, sieve or filter element 5 ensures that only small-size acceptable particles 6 can pass through the filter element 5 and further into a pipe connection 8 in which suction is provided, whereby only large-size particles 6 are retained in the cup 3.

FIG. 1d shows how the sample 2 is inspected by a camera 11 and in case of particles 6 in the cup 3, corrective action is taken. Finally, the cup 3 is emptied for any particles 6 as shown in FIG. 1e.

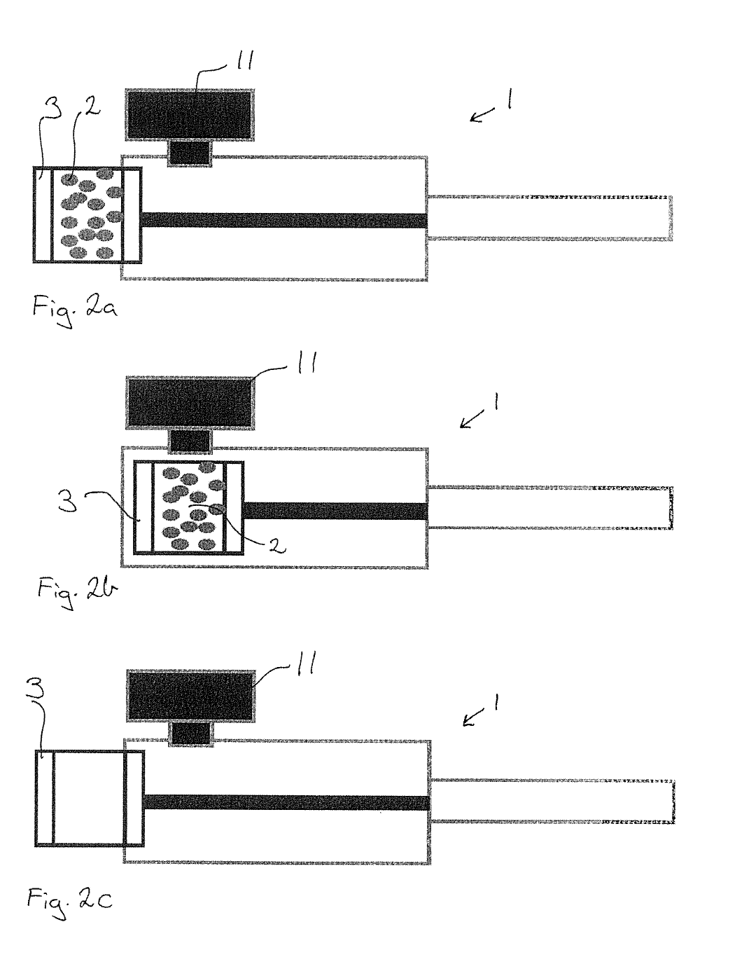

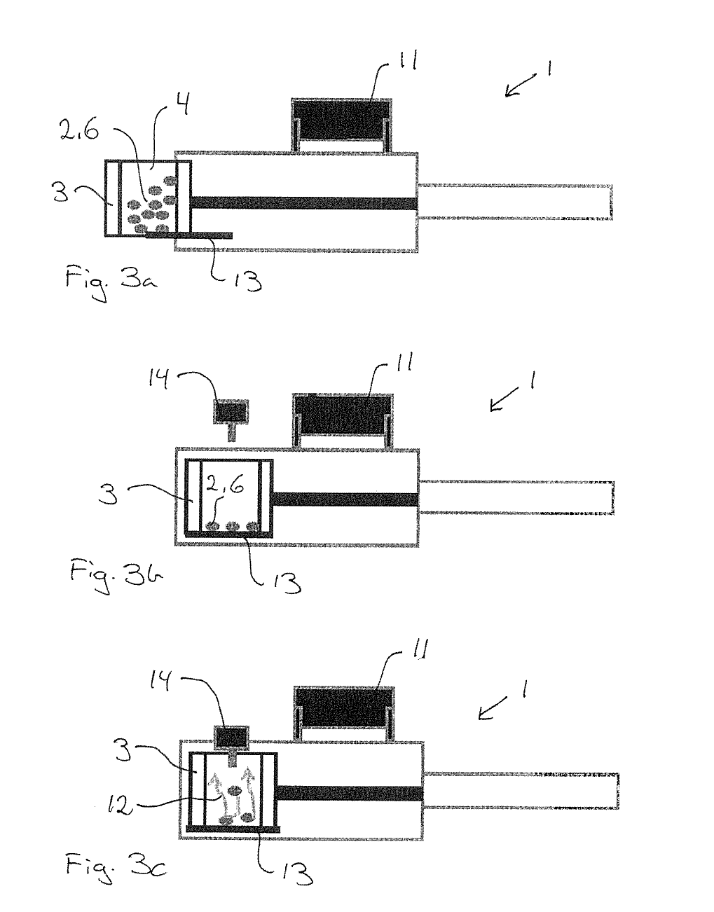

FIGS. 2a-2c show an example of a simple but important test process, viz. inspection of a product sample 2 in a cup 3 which inspection can focus for example, on color differences, weight and/or water contents or something quite different. Below follows an example of a situation where such a solution can advantageously be applied.

In a spray drying process, local burns of the product may occur, for example, in a milk powder product. Thereby the powder is contaminated which should preferably be completely white and free of burned particles. Using an apparatus 1 for online sampling, a sample 2 taken from a product flow of milk powder can continuously be monitored in order to determine whether there are foreign bodies in the sample 2. This is performed by inspecting the product sample 2 by means of a sensor, for example, a camera 11 upon which the photo taken is processed using photo processing software. By means of this software the photo can easily and rapidly be automatically analysed to determine whether there are particles having a color deviating from the wanted color or deviating from the dominant color of the sample 2.

FIG. 2a shows an apparatus 1 for online sampling where a cup 3 is filled with a sample 2 that has been taken from a product flow. FIG. 2b shows the sample 2 placed under a sensor, which, in the embodiment shown, is a camera 11 by means of which it is checked whether there are black particles in the white powder. If dark particles are found to be in the sample 2, an alarm is given, and corrective action can be taken. FIG. 2c shows the apparatus 1 immediately after the cup 3 has been emptied and in position in the product flow for collection of a new sample 2.

As mentioned above, an apparatus as shown in FIG. 2 can be provided with various sensor types and can thus also comprise one sensor head 11 composed of various sensors for determining various conditions of a sample 2. In the example above camera 11 is, for example, used, and in certain cases, this camera 11 can be supplemented or replaced by other sensors.

In certain cases, it may be wanted to initiate sampling by performing a sort of cleaning of the cup 3. Such cleaning can for example, be performed by exposing an empty cup 3 to ultraviolet light (UV) from a UV light source 11 which can advantageously be integrated with one or more other sensors in a sensor unit 11. The UV light considerably removes or reduces bacteria in the cup 3 by which it is ensured that future measurement results will not be affected by a previous contaminated sample 2 and thereby also by a contaminated cup 3. By exposing at least the cup 3 to ultraviolet light, and in certain cases, maybe also the sample 2 itself, it is to a high degree ensured that bacteria are removed, if any, or their number limited. Up till now, it has been customary to perform such cleaning by using detergents, but by using a solution as the one described here, thorough and manual cleaning can be fully or partially dispensed with, while at the same time the risk of contamination of the cup 3 and the product itself is considerably reduced. The use of UV light in a cup 3 can advantageously be performed prior to taking out a sample 2, and in certain cases, it can be advantageous to apply UV light both immediately before a sample 2 is taken, but also immediately after a sample 2 has been emptied from the cup 3 as there will be favorable conditions for bacteria growth in a cup 3 where there may be small amounts left of the sample 2.

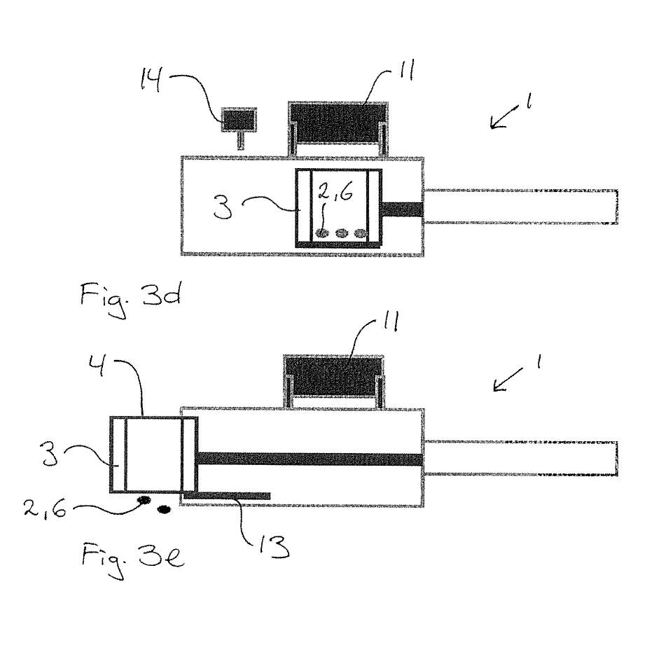

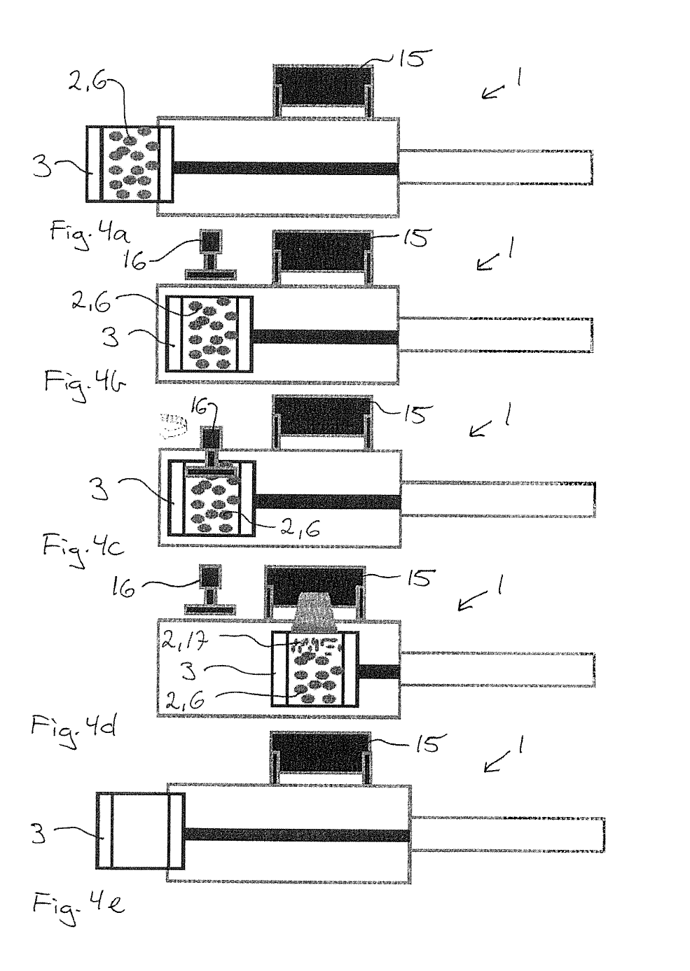

FIGS. 3a-3e show an example of a process procedure in which a sample 2 having a limited volume is taken where the individual products 6 in the sample 2 are analyzed with a special view to size. In an extrusion process for the manufacturing of, for example, pelleted pet food for dogs, cats, fish etc., there may be conditions relating to the size of the individual pellets 6 rendering it relevant to measure a sample 2 of pellets 6. This can for example, be with focus on length, diameter and surface area of the individual pellets 6. With an apparatus 1 for online sampling it is possible to take out a small amount of pellets 6. The pellet amount is aerated, partly in order to separate the pellets 6 from each other, as they may be sticky, and for extracting the vapor 12 which may be available in the sample 2. Thereupon a photo is taken which subsequently is subjected to electronic and automatic photo processing with software suitable for this purpose. FIG. 3a shows a cup 3 placed in a product flow having its bottom 13 partly open. In this way it is ensured that only a sample 2 with a limited volume is taken. When the cup 3 is retracted to the apparatus 1, the bottom 13 is closed. FIG. 3b shows the sample 2 at the bottom 13 of the cup 1 The cup 3 is placed under an aeration nozzle 14 which here is connected to compressed air which can be led down into the cup 3. This can be seen in FIG. 3c where air is led to the cup 3 by which vapor 12 is removed from the pellets 6 and the cup 3. The aeration nozzle 14 is arranged in such a way that it can cover the opening 4 of the cup 3 to a larger or smaller degree and thereby prevent the pellets 6 from being blown out of the cup 3. At the same time as when the pellets 6 are aerated, they are also distributed at the bottom 13 of the cup 3. When the pellets 6 have been distributed more or less evenly at the bottom 13 of the cup 3, this is arranged under a sensor, such as a camera 11 which can be seen in FIG. 3d by which the individual pellets 6 via photo processing equipment can be measured on the basis of one or more photos. FIG. 3e shows the processed sample 2 being returned to the process.

FIGS. 4a-4e show an example of how a sample 2 is exposed to mechanical treatment, in this case grinding of the product in the sample taken. Subsequently, a so-called NIR (near infrared) analysis is made. NIR analyses of, for example, pet foods and cereals are often made in a continuous product flow where the NIR sensor 15 is placed over a conveyor band, for example. When the product 6 passes the NIR sensor 15, infrared light is emitted which is reflected by the product 6 upon which the contents of fat, protein and water can be read. The problem of using NIR analysis, especially for extruded pellets 6 is that the material in the centre of the pellet 6 is not identical to the material in the periphery of the pellet 6. As the NIR analysis is only made on the surface area of the product 6, no usable measurement data are obtained, as there is a difference between data measured on the surface area and data measured in the centre of the pellet 6. At the same time it may be difficult to calibrate the NIR sensor 15. The reason for this is that when working with a continuous product flow, it cannot be guaranteed that the sample 2 on which measurement is being performed corresponds to the reference sample used. An NIR instrument must be calibrated to the reference sample. FIG. 4a shows an apparatus 1 for online sampling where a cup 3 is filled with a sample 2 composed of extruded pellets 6. In FIG. 4b, the sample 2 is drawn into the apparatus 1 and arranged under a mechanical tool 16, for example, a rotating knife 16. In FIG. 4c, this rotating knife 16 is brought into contact with the content 2, 6 in the cup 3 by which this is ground or pulverized to significantly smaller particles 17 than the original pellet form 6. FIG. 4d shows the cup 3 with the sample 2 brought in position under an NIR sensor 15 by which certain properties and conditions of the ground product 6, 17 can be determined. Finally the cup 3 is emptied for the product 6, 17 as is seen in FIG. 4e.

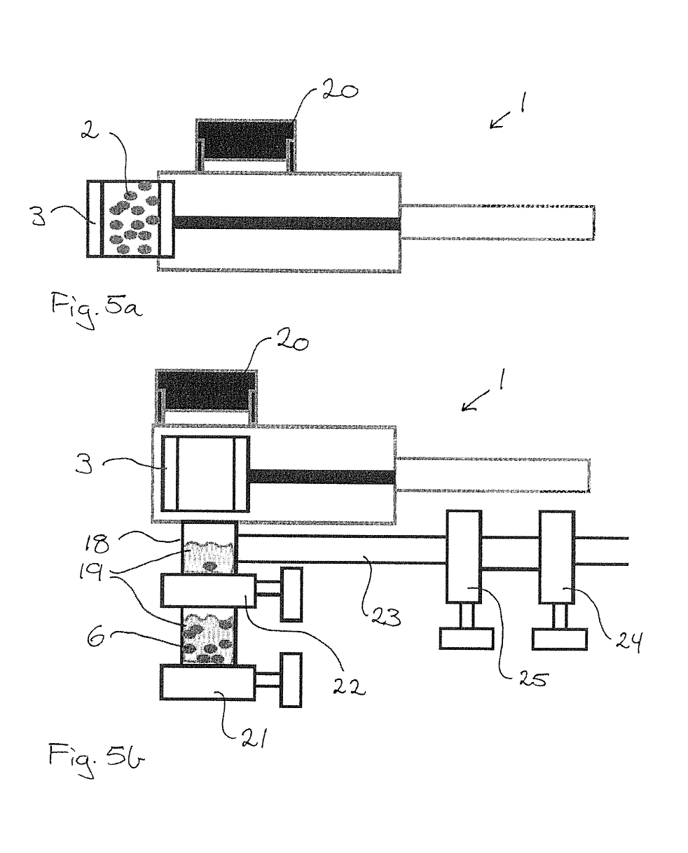

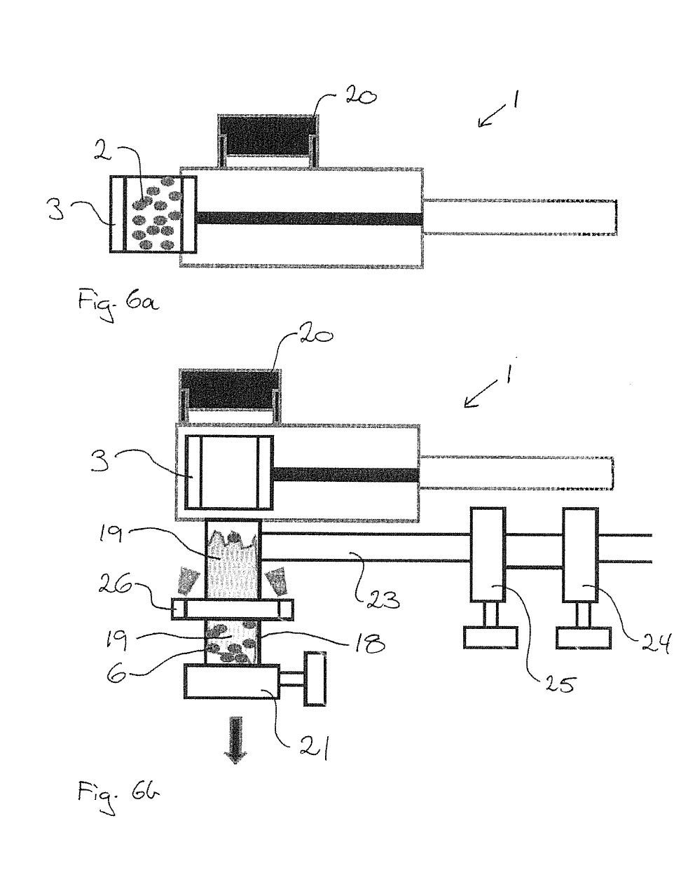

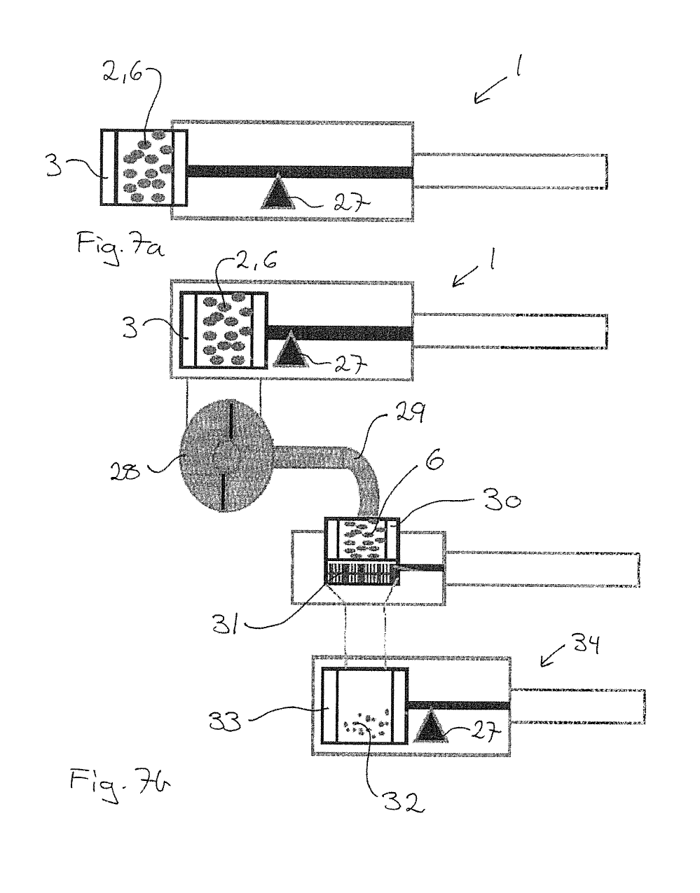

FIG. 5 shows how an apparatus 1 for online sampling is used in connection with test of the floating properties of a product. An apparatus 1 according to the invention can advantageously be used in connection with manufacturing of fish fodder 6 of the type used for various types of fish farming in lakes and at sea in basins designed for this purpose. Some fishes eat at the water surface, whereas other fishes eat below the water surface at a more or less precisely given depth. For fishes eating below the water surface, it is essential that the fodder 6 sinks down into the water when it is dispersed for example, in a fish farm at sea. If the fodder floats upon or very close to the water surface, there is a strong probability that the fodder will not be eaten. Thus the fish will not get the optimum amount of fodder 6. The opposite is applicable in connection with feeding fish eating at the surface of the water. In this case, it is important that the fodder 6 does in fact not sink towards the bottom but remains floating for as long as it takes the fish to eat it. At the end of the manufacturing process for fish fodder 6, it is therefore desired to be able to perform an automatic float test to determine whether the fodder 6 floats, floats in part, or sinks, and the speed or delay by which this happens. These conditions can advantageously be tested in water where salt content and/or other parameters have been adjusted to the same conditions as those present where the fodder is to be used. It is commonly known to take a sample automatically which is hereafter discharged automatically to a container with water upon which it is manually tested whether the pellets 6 are floating or sinking. As mentioned, this is a manual process, and it is desirable that it is possible to automatically test the sinking or floating capability of the fodder. Using an apparatus 1 for online sampling according to the invention, a sample 2 is automatically taken, and the sample 2 is led down through a pipe 18 with water 19. Water 19 has been adjusted to the conditions present at where the fodder is intended to be used. FIG. 5a shows an apparatus 1, with a cup 3 containing a sample 2. On the apparatus, a sensor 20 has been arranged for determining a number of non-well-defined physical properties of the product 6 in the sample 2. FIG. 5b shows that the apparatus 1 comprises further arrangements connected to the bottom side of the apparatus. In the example shown, these further arrangements comprise a vertical pipe 18 provided with a bottom valve 21 and a central valve 22. Above the central valve 22, a horizontal pipe 23 is connected to the vertical pipe 18. The horizontal pipe 23 is also provided with valves, viz. a first valve 24 and a second valve 25. Via the pipe 23, water 19 is led in between the first valve 24 and the second valve 25 by which an appropriate amount of water 19 is measured by closing of the valves 24 and 25. The amount of water 19 measured can now be led to the vertical pipe 18 which is shut at the bottom valve 21. When water 19 has been supplied to the vertical pipe 18, or at the same time as this occurs, the sample 2 of fodder 6 is also supplied down into the vertical pipe 18. After a predefined or certain period of time, the central valve 22 is shut, and detection can be performed by means of the sensor 20, which can be a camera, to determine whether there are products 6 in the water above the central valve 22. With such an arrangement it is possible to determine whether a product 6 will sink to the bottom, and how long time this takes. Upon completion of detection, both the bottom valve 21 and the central valve 22 are opened, and water 19 and product 6 are discharged. When performing detection as shown in FIG. 5, it may be advantageous that the internal surfaces in the vertical pipe 18 and on the central valve 22 are made with a light color on the surface by which detection using a camera 20 is facilitated.

FIGS. 6a & 6b show another embodiment of an apparatus 1 for online sampling which is also suitable for use in connection with test of the floating properties of a product. The overall difference is that the central valve 22 as is shown in FIG. 5b has been replaced by a number of sensors 26 or cameras 26 which “look” up under the surface of the water 19 and thereby up under products 6, if any, in the water surface. Depending on the intended use of the product corrective action can be performed if required, on the basis of the detection performed.

Finally, FIG. 7 shows an embodiment of an apparatus 1 for online sampling where the apparatus is used in connection with a hardness test of pellets 6 where the pellets can for example, be fish fodder. Especially in connection with manufacturing of extruded pellets 6 which are expanded and therefore may have a tendency to being partly fragile, it is commonly known that it is always necessary to test the hardness of the products 6 in order thereby to determine whether they will be damaged after packing or during further handling. As pellets having insufficient durability cannot be used in an optimum way, it is important to perform such continuous tests. However, up till now such tests have comprised much manual labor while, at the same time, being connected with a degree of uncertainty. By use of the invention, it is possible to take out a sample 2 automatically which is treated mechanically by a certain action upon the individual pellets 6 in a sample 2 upon which the sample is analyzed for the amounts of dust and fragments (parts of the pellets). This result can hereafter be used in connection with automatic definition of the strength of the pellet.

FIG. 7a shows an apparatus 1 for online sampling where a cup 3 is filled with a sample 2, in this case being pellets 6. The apparatus comprises a weighing unit 27 for determining the weight of the total sample. After the sample has been weighed, the cup 3 is emptied and the pellets 6 are led down into a mechanical action exertion system 28. This mechanical action exertion system can advantageously be an apparatus corresponding to the type of apparatuses used for distributing fodder in for example, a fish farm. It is typically an apparatus provided with rotating means by which the fodder is thrown out over the water. In this connection, it is important that the fodder can sustain this treatment without the individual pellets being damaged, as the fish will not eat the resulting fragments and dust, and as the pellets 6 will not be thrown by the distance expected when they are not whole. Thus it is important that the pellets have the hardness expected in order to comply with the quality requirements.

FIG. 7b shows an apparatus 1 with a sample 2, 6 taken and weighed. The pellets 6 in the sample 2 are led down into the mechanical action exertion system 28 and are thrown further to a pipe 29, and are finally collected in a collection cup 30 where the bottom 31 is provided with openings by which whole or acceptable pellets 6 are retained, while small fragments and dust 32 are collected in a further cup 33. The size of the openings in the bottom 31 is adapted to the actual pellets, and the bottom 31 can be exchanged with another bottom having larger or smaller openings, according to need. The fragments and dust 32 collected in the cup 33 are weighed by means of a weighing unit 27 in an apparatus 34 designed for this purpose by which it is possible to determine whether a too large or acceptable part of the pellets 6 have been damaged during the action exerted. Depending on whether the result is within the given range or not, corrective action can be taken in the manufacturing process.

1. An apparatus for online sampling from a product flow, where the sampling is performed continuously by introducing a cup, provided with an opening, directly into a product flow where the flowing product is collected in said cup for determining one or more physical conditions of the sample, the apparatus comprises at least a slidable cup and means for sliding said cup, wherein the apparatus further comprises a filter element and means by which the filter element is brought into position in relation to an opening in said cup, aeration means for aeration of the sample taken in the cup, and further comprises at least a set of sensor means for determining the presence of contents and/or physical conditions of the contents in the cup.

2. An apparatus for online sampling according to claim 1, wherein said means for positioning the filter element in relation to the cup are adjustable and arranged in such a way that the distance between the filter element and the cup can be adjusted.

3. An apparatus for online sampling according to claim 1, wherein said aeration means comprise at least one opening through which compressed air is supplied or a suction is provided where said at least one opening is in direct or indirect connection with the cup or filter element of the apparatus.

4. An apparatus for online sampling according to claim 1, wherein the apparatus includes a sensor in the form of a camera.

5. An apparatus for online sampling according to claim 1, wherein the apparatus comprises means for detection of contents of fat, protein and/or water, for example an IR (infrared) or NIR (near infrared) sensor.

6. An apparatus for online sampling according to claim 1, wherein the apparatus comprises means for exertion of a mechanical action on the product sample taken from the product flow.

7. An apparatus for online sampling according to claim 1, wherein the apparatus comprises means for grinding a product sample in the cup.

8. An apparatus for online sampling according to claim 1, wherein the apparatus comprises a liquid-filled chamber and means for positioning the product sample taken in the liquid-filled chamber, and further comprises means for determining whether a part of the product floats in the liquid after an adjustable interval of time.

9. for online sampling from a product flow by means of an apparatus that comprises at least a slidable cup and means for sliding said cup, wherein the apparatus further comprises a filter element and means by which the filter element is brought into position in relation to an opening in said cup, aeration means for aeration of the sample taken in the cup, and further comprises at least a set of sensor means for determining the presence of contents and/or physical conditions of the contents in the cup, where the sampling is performed continuously by introducing a cup, provided with an opening, directly into a product flow where the flowing product is collected in said cup for determining one or more physical conditions, wherein the method comprises at least three of the following four steps:
taking a sample
arranging the sample taken in a detection area
aeration of the sample by means of compressed air or suction and thereby filtration of the product
activation of a sensor for determining the presence and/or size of products in the cup.

10. A method according to claim 9, wherein the method comprises at least one of the following steps:
determining the weight of either the residue product or the filtrate product.
determining the size of residue products.
determining the number of residue products.

11. Method for online sampling according to claim 9, wherein the one or more physical conditions of the sample determined with the sensor means are at least one of weight in relation to volume, moisture, size and color.

12. Apparatus for online sampling according to claim 1, wherein the one or more physical conditions of the sample determined with the sensor means are at least one of weight in relation to volume, moisture, size and color.
